(19) United States
(12) Patent Application Publication
(10) Pub. No.: US 2019/0150131 A1
(43) Pub. Date: May 16, 2019

(54) BASE STATION, USER EQUIPMENT AND COMMUNICATION METHOD USED IN WIRELESS COMMUNICATION SYSTEM

(71) Applicant: FUJITSU LIMITED, Kawasaki-shi (JP)

(72) Inventors: Hongyang CHEN, Kawasaki (JP); Tsuyoshi Shimomura, Yokohama (JP); Jianming Wu, Kawasaki (JP); YOSHINORI TANAKA, Yokohama (JP)

(73) Assignee: FUJITSU LIMITED, Kawasaki-shi (JP)

(21) Appl. No.: 16/248,987

(22) Filed: Jan. 16, 2019

Related U.S. Application Data
(63) Continuation of application No. PCT/JP2016/073607, filed on Aug. 10, 2016.

(51) Int. Cl. H04W 72/04; H04L 5/14; H04L 5/00

(52) U.S. Cl. CPC H04W 72/042; H04L 5/0092; H04L 5/0007; H04L 5/143

(57) ABSTRACT

A base station device communicates with a user equipment by using a frame including a downlink region in which a signal for a downlink is allocated and an uplink region in which a signal for an uplink is allocated. The base station device includes: a guard period determination unit, a frame configuration determination unit, a notification unit, and a communication circuit. The guard period determination unit determines a length of a guard period provided between the downlink region and the uplink region based on a transmission delay between the base station device and the user equipment. The frame configuration determination unit determines a configuration of the frame based on the length of the guard period. The notification unit notifies the user equipment of configuration information that indicates the configuration of the frame. The communication circuit communicates with the user equipment based on the configuration of the frame.

### CROSS-REFERENCE TO RELATED APPLICATION

This application is a continuation application of International Application PCT/JP2016/073607 filed on Aug. 10, 2016 and designated the U.S., the entire contents of which are incorporated herein by reference.

### FIELD

The embodiments discussed herein are related to a base station, a user equipment and a communication method used in a wireless communication system.

### BACKGROUND

Wireless communication traffic has been increased in recent years. Various wireless communication applications have been provided. Accordingly, International Telecommunication Unit (ITU) and Third Generation Partnership Project (3GPP) have provided future communication schemes (see, for example, documents 1-3).
Document 1: ITU-R Recommendation ITU-R M.2083-0 (09/2015) IMT Vision Framework and overall objectives of the future development of IMT for 2020 and beyond
Document 2: Technical Specification Group Radio Access Network; Study on Scenarios and Requirement for Next Generation Access Technologies (Release 14), 3GPP TR 38.913 V0.3.0
Document 3: 3GPP RP-160671, New SID Proposal, Study on New Radio Access Technology, NTT DOCOMO, 3GPP TSG RAN Meeting #71, Mar. 7-10, 2016

Frame structures of next-generation wireless communication schemes (e.g., Fifth Generation (5G) scheme) are designed to implement various services efficiently. Next-generation wireless communication schemes support, for example, the Enhanced Mobile Broadband (eMBB), the Ultra-Reliable and Low-Latency Communication (URLLC), and the massive Machine Type Transmission (mMTC). Large capacity communications with a high frequency are needed for eMBB. Small delay and high reliability are needed end-to-end for URLLC. URLLC may be applied to, for example, automatic driving systems.

Communications with a small payload size and relaxed delay requests are performed in mMTC. In mMTC, however, data is transmitted from many nodes. mMTC may be applied to, for example, a sensor network system for collecting information from many sensors.

As in the existing Long Term Evolution (LTE) scheme, subframes are defined in the 5G new wireless scheme (5GNR: 5G New Radio). A subframe indicates a base time unit for mapping a physical channel and a signal to a radio resource. A subframe also indicates a timing for a procedure of a communication between a base station and a terminal.

In a wireless communication, three types of subframes may be used. A subframe of type 1 includes a downlink region only, as depicted in FIG. 1A. A downlink region is used to transmit data or a signal from a base station to a terminal. A subframe of type 2 includes an uplink region only, as depicted in FIG. 1B. An uplink region is used to transmit data or a signal from a terminal to a base station. A subframe of type 3 includes a downlink region and an uplink region, as depicted in FIGS. 1C and 1D. A subframe that includes a downlink region and an uplink region may hereinafter be referred to as a “DL-UL mixed subframe”. A DL/UL mixed subframe is used in Time

Division Duplex (TDD).

A downlink region is dominant in the DL-UL mixed subframe depicted in FIG. 1C. In this case, the uplink region is used to transmit, for example, uplink control information or a sounding reference signal (SRS). An uplink region is dominant in the DL-UL mixed subframe depicted in FIG. 1D. In this case, the downlink region is used to transmit, for example, downlink control information.

A DL-UL mixed subframe is provided with a guard period (GP) between a downlink region and an uplink region, as depicted in FIGS. 1C and 1D. Providing the guard period prevents or mitigates an occurrence of interference between the downlink and the uplink. The guard period is described in, for example, document 4.
Document 4: R1-081563, On UL/DL frame timing for TDD, Ericsson, TSG-RAN WG1 #52bis, Mar. 31 to Apr. 4, 2008

In an existing technique, the length of a guard period in a DL-UL mixed subframe is fixedly designated in advance. When, for example, a base station accommodates a plurality of user equipments, all subframes transmitted between the base station and each user equipment include guard periods with the same length.

However, a guard period length that is needed depends on the environment of a communication between a base station and a user equipment. Hence, fixedly designating the length of a guard period in a subframe in advance may result in a decrease in the efficiency in use of radio resources.

### SUMMARY

According to an aspect of the present invention, a base station device communicates with a user equipment by using a frame including a downlink region in which a signal for a downlink is allocated and an uplink region in which a signal for an uplink is allocated. The base station device includes: a guard period determination unit configured to determine a length of a guard period provided between the downlink region and the uplink region based on a transmission delay between the base station device and the user equipment; a frame configuration determination unit configured to determine a configuration of the frame based on the length of the guard period; a notification unit configured to notify the user equipment of configuration information that indicates the configuration of the frame determined by the frame configuration determination unit; and a communication circuit configured to communicate with the user equipment based on the configuration of the frame determined by the frame configuration determination unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A, 1B, 1C and 1D illustrate examples of the configurations of subframes;

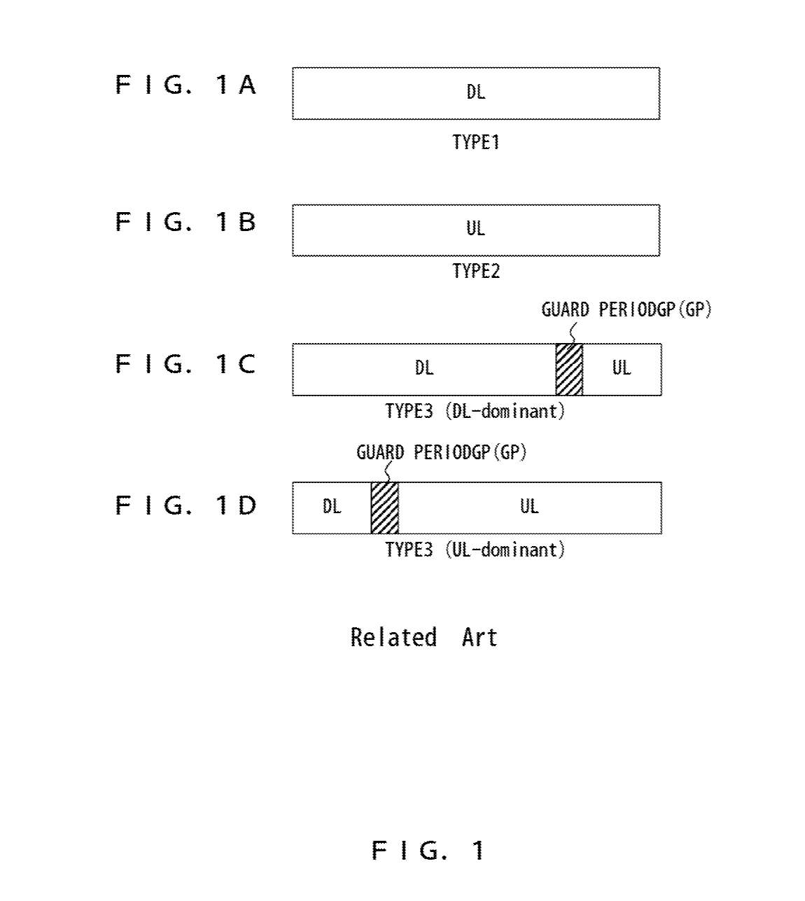

FIG. 2 illustrates an example of a wireless communication system;

FIG. 3 illustrates an example of a user equipment;

FIG. 4 illustrates an example of a base station;

FIGS. 5A and 5B illustrate examples of guard periods and reuse of radio resources;

FIGS. 6A and 6B illustrate examples of sequences for establishing a wireless link;

FIG. 7 illustrates an example of eNB functions related to resource allocation;

FIG. 8 is a flowchart indicating an example of a process performed by an eNB in a sequence for establishing a wireless link;

FIG. 9 illustrates an example of UE functions related to resource allocation;

FIG. 10 is a flowchart indicating an example of a process performed by a UE in a sequence for establishing a wireless link;

FIG. 11 illustrates an example of a sequence for reusing radio resources;

FIG. 12 illustrates an example of a UE management table;

FIG. 13 is a flowchart indicating an example of a process of reusing radio resources;

FIGS. 14A and 14B illustrate examples of allocation and reuse of radio resources;

FIG. 15 illustrates an example of the grouping of UEs;

FIG. 16 illustrates an example of a rule for reusing radio resources;

FIG. 17 illustrates another example of a sequence for reusing radio resources;

FIGS. 18A, 18B, 18C and 18D illustrate examples of subframes; and

FIG. 19 illustrates examples of radio frames.

### DESCRIPTION OF EMBODIMENTS

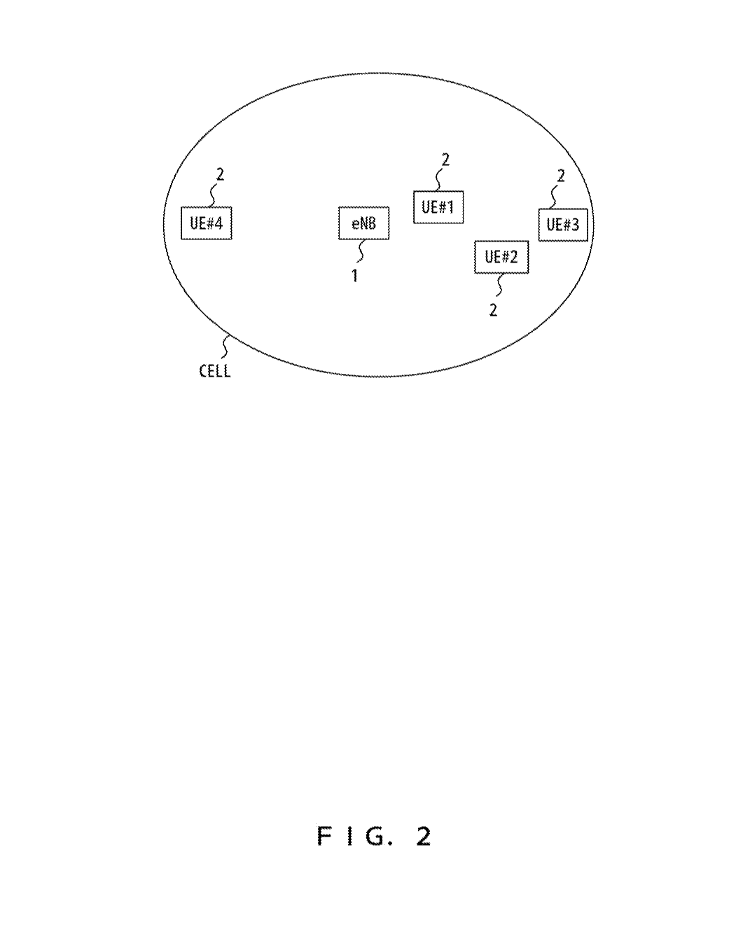

FIG. 2 illustrates an example of a wireless communication system in accordance with embodiments of the present invention. The wireless communication system depicted in FIG. 2 includes a base station 1 and user equipment 2. In this example, the base station 1 is an evolved Node B (eNB). The user equipment 2 is a user equipment (UE). In the example depicted in FIG. 2, a plurality of user equipments (UE#1-UE#4) are located within a cell covered by the base station 1.

UE#1 is located close to the base station 1. UE#3 and UE#4 are respectively located in the vicinity of an edge of the cell covered by the base station 1. That is, UE#3 and UE#4 are respectively located at a position distant from the base station 1. A distance between UE#2 and the base station 1 is longer than a distance between UE#1 and the base station 1 and shorter than a distance between UE#3 and the base station 1.

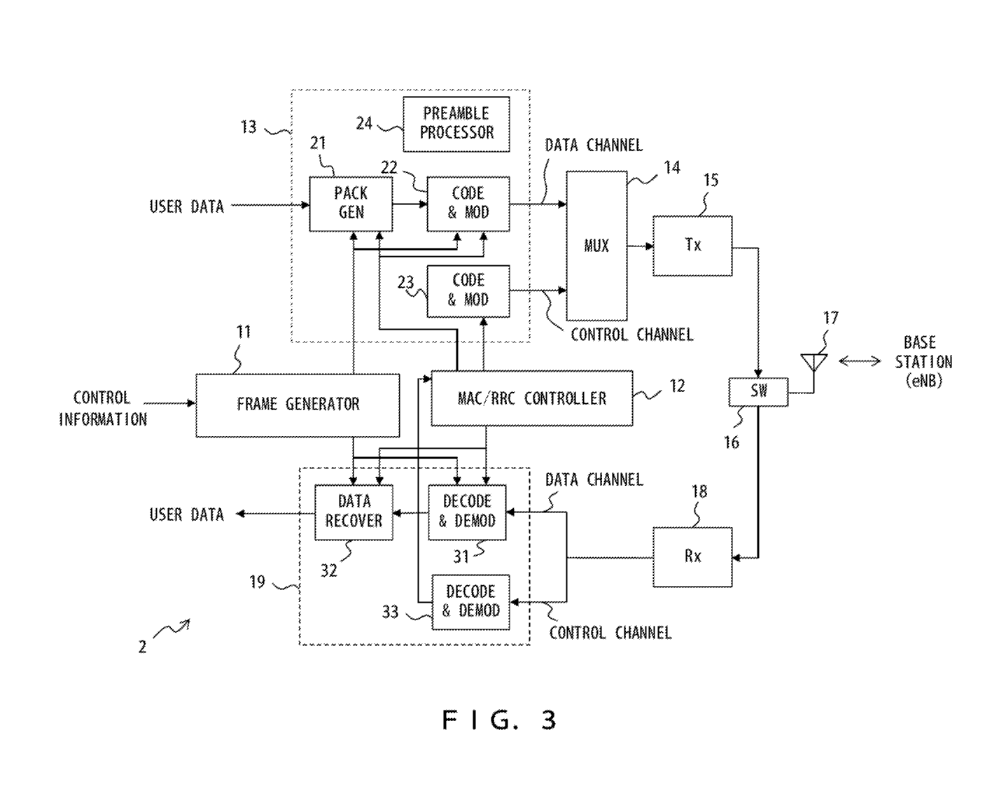

FIG. 3 illustrates an example of the user equipment 2 in accordance with embodiments of the invention. As depicted in FIG. 3, the user equipment (UE) 2 includes a frame generator 11, a MAC/RRC controller 12, a transmission circuit 13, a multiplexer 14, a radio transmitter 15, a switch 16, an antenna 17, a radio receiver 18, and a reception circuit 19. However, the user equipment 2 may include other circuit elements that are not depicted in FIG. 3.

According to control information (this will be described hereinafter), the frame generator 11 determines a configuration for a radio frame or subframe to be transmitted between the user equipment 2 and the base station 1. A radio frame includes a plurality of subframes. In the following example, the frame generator 11 determines a configuration for a subframe.

The MAC/RRC controller 12 performs the Medium Access Control (MAC) and the Radio Resource Control (RRC). In particular, the MAC/RRC controller 12 performs signal processing for layers L1-L3.

The transmission circuit 13 includes a packet generator 21, coder/modulators 22 and 23, and a preamble processor 24. The packet generator 21 generates a data packet from user data under the control of the frame generator 11 and the MAC/RRC controller 12. The coder/modulator 22 generates a data signal by coding and modulating a data packet. The data signal may be transmitted from the user equipment 2 to the base station 1 via a Physical Uplink Shared Channel (PUSCH). The coder/modulator 23 may generate control signals such as MAC signaling signals and RRC signaling signals. The control signal maybe transmitted from the user equipment 2 to the base station via a Physical Uplink Common Channel (PUCCH). The preamble processor 24 generates a preamble signal. The preamble signal is transmitted from the user equipment 2 to the base station 1 via a Physical Random Access Channel (PRACH).

The multiplexer 14 multiplexes a data channel and a control channel. The radio transmitter 15 converts an output signal of the multiplexer 14 into a signal in a radio frequency band. The radio transmitter 15 may also convert a preamble signal into a signal in a radio frequency band. The switch 16 provides the Time Division Duplex (TDD) by switching between a transmission signal and a reception signal. The antenna 17 transmits a radio signal to the base station 1 and receives a radio signal from the base station 1.

The radio receiver 18 down-converts a signal received from the base station 1. Output signals of the radio receiver 18 include data signals and control signals. The data signal may be transmitted from the base station 1 to the user equipment 2 via a Physical Downlink Shared Channel (PDSCH). The control signal may be transmitted from the base station 1 to the user equipment 2 via a Physical Downlink Common Channel (PDCCH).

The reception circuit 19 includes a demodulator/decoder 31, a data recovery 32, and demodulator/decoder 33. The demodulator/decoder 31 demodulates and decodes a data signal received from the base station 1. The data recovery 32 recovers data from an output signal of the demodulator/decoder 31. The demodulator/decoder 33 recovers control information from a control signal received from the base station 1.

The frame generator 11 and the MAC/RRC controller 12 are implemented by, for example, a processor system that includes a processor element and a memory. In this case, the processor system provides functions of the frame generator 11 and the MAC/RRC controller 12 by executing a program supplied thereto.

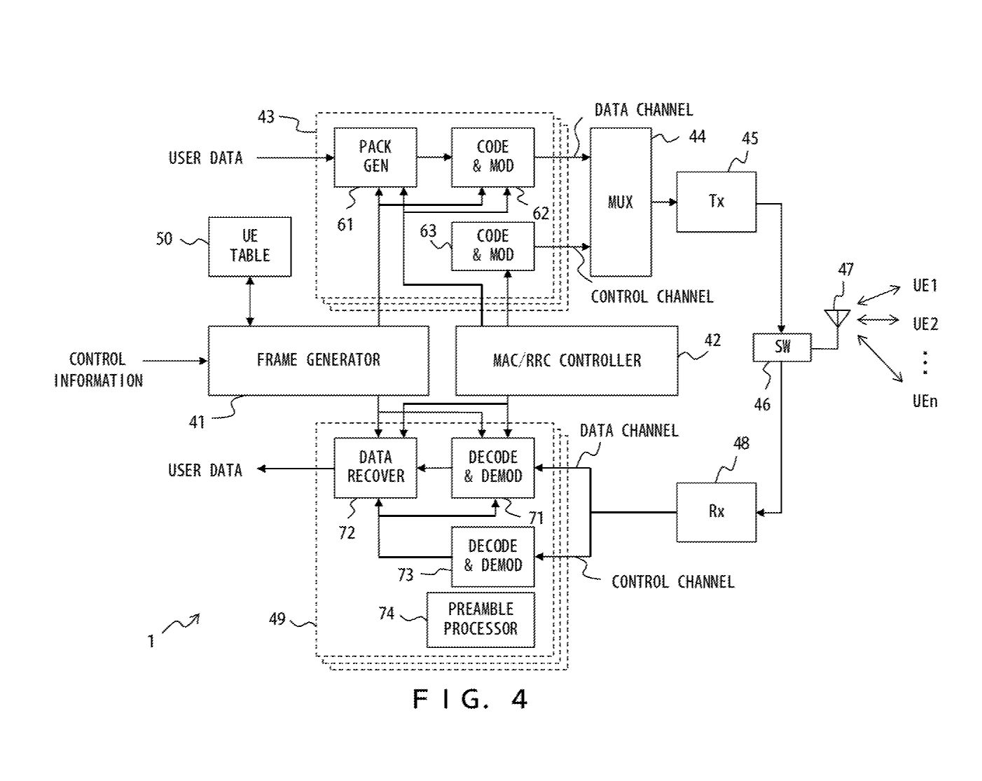

FIG. 4 illustrates an example of the base station 1 in accordance with embodiments of the invention. As depicted in FIG. 4, the base station (eNB) 1 includes a frame generator 41, a MAC/RRC controller 42, a plurality of transmission circuits 43, a multiplexer 44, a radio transmitter 45, a switch 46, an antenna 47, a radio receiver 48, a plurality of reception circuits 49, a UE management table 50. However, the base station 1 may include other circuit elements that are not depicted in FIG. 4.

According to control information (this will be described hereinafter), the frame generator 41 determines a configuration for a subframe to be transmitted between the base station 1 and the user equipment 2. The MAC/RRC controller 42 performs MAC and RRC.

Each of the transmission circuits 43 includes a packet generator 61 and coder/modulators 62 and 63. The packet generator 61 generates a data packet from user data under the control of the frame generator 41 and the MAC/RRC controller 42. The coder/modulator 62 generates a data signal by coding and modulating the data packet. The data signal may be transmitted from the base station 1 to the user equipment 2 via a PDSCH. The coder/modulator 63 may generate control signals such as MAC signaling signals and RRC signaling signals. The control signal may be transmitted from the user equipment 2 to the base station 1 via a PDCCH.

The multiplexer 44 multiplexes a data channel and a control channel generated by each transmission circuit 43. The radio transmitter 45 converts an output signal of the multiplexer 44 into a signal in a radio frequency band. The switch 46 provides TDD by switching between a transmission signal and a reception signal. The antenna 47 transmits a radio signal to each user equipment 2 and receives a radio signal from each user equipment 2.

The radio receiver 48 down-converts a signal received from each user equipment 2. Output signals of the radio receiver 48 include data signals and control signals. The data signal may be transmitted from the user equipment 2 to the base station 1 via a PUSCH. The control signal may be transmitted from the user equipment 2 to the base station 1 via a PUCCH.

Each reception circuit 49 includes a demodulator/decoder 71, a data recovery 72, demodulator/decoder 73, and a preamble processor 74. The demodulator/decoder 71 demodulates and decodes a data signal received from a corresponding user equipment 2. The data recovery 72 recovers data from an output signal of the demodulator/decoder 71. The demodulator/decoder 73 recovers control information from a control signal received from a corresponding user equipment 2. The preamble processor 74 processes a preamble signal received from a corresponding user equipment 2.

For each user equipment 2 located within the cell, the UE management table 50 may store configuration information indicating the configuration of a subframe to be used. The configuration of a subframe is defined by a DL/UL ratio and the length of a guard period (these will be described hereinafter). The UE management table 50 may store reuse information (this will be described hereinafter) for each user equipment 2.

The frame generator 41 and the MAC/RRC controller 42 are implemented by, for example, a processor system that includes a processor element and a memory. In this case, the processor system provides functions of the frame generator 41 and the MAC/RRC controller 42 by executing a software program.

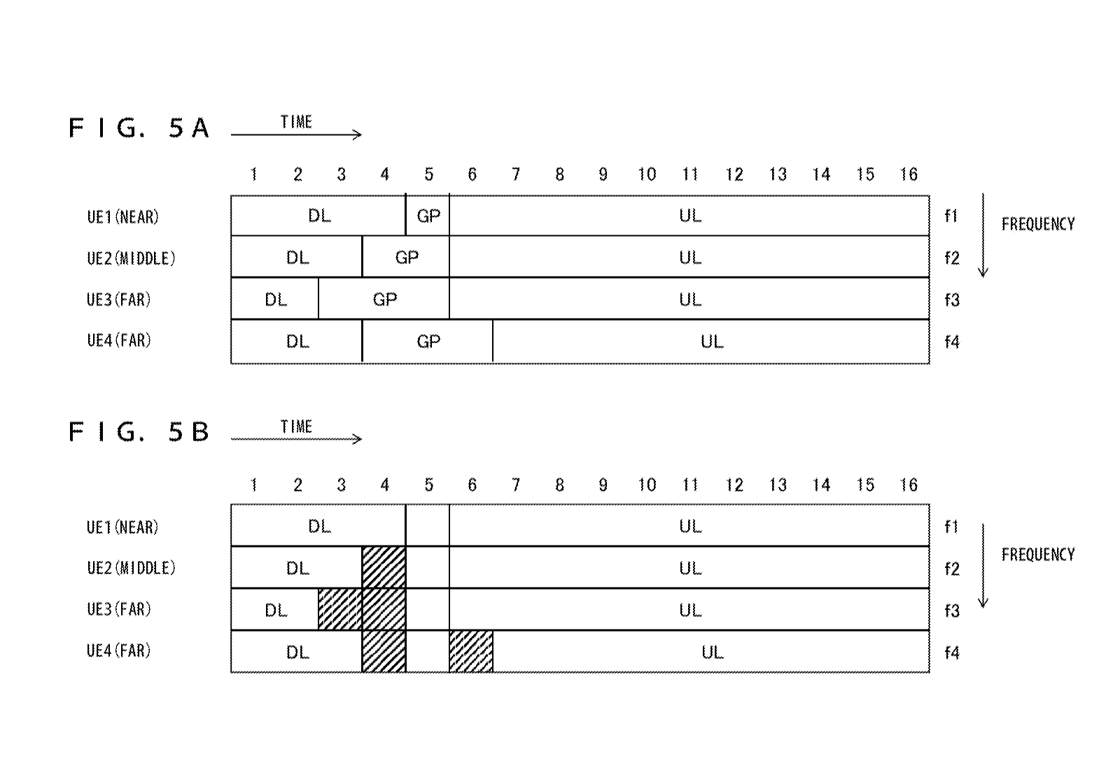

FIGS. 5A and 5B illustrate examples of resource allocation in accordance with embodiments of the invention. Allocation of radio resources is defined by the configuration of a subframe. In this example, a subframe includes sixteen symbols in a time domain. A subframe also includes one or more subcarriers in a frequency domain. The plurality of subcarriers each have a different frequency. Also in this example, a subframe includes a downlink region in which a signal to be transmitted from the base station 1 to the user equipment 2 is allocated and an uplink region in which a signal to be transmitted from the user equipment 2 to the base station 1 is allocated.

A guard period (GP) is provided between a downlink region and an uplink region. The guard period is provided to prevent or mitigate an occurrence of interference between a downlink and an uplink. Accordingly, no signals are transmitted during the guard period. A guard period length that is needed may depend on a period of a round trip between the base station 1 and the user equipment 2. Accordingly, a guard period length is determined according to a transmission delay (or propagation delay) between the base station 1 and the user equipment 2.

In the example depicted in FIG. 2, UE#1 is located in the vicinity of the eNB (i.e., base station 1). In this case, a short guard period is provided in a subframe transmitted between the eNB and UE#1. In the example depicted in FIG. 5A, the length of a guard period in a subframe transmitted between the eNB and UE#1 is one symbol period.

The distance between the eNB and UE#2 is longer than the distance between the eNB and UE#1. Hence, the guard period in a subframe transmitted between the eNB and UE#2 is longer than the guard period in a subframe transmitted between the eNB and UE#1. In the example depicted in FIG. 5A, the length of a guard period in a subframe transmitted between the eNB and UE#2 is two symbol periods.

The distance between the eNB and UE#3 is longer than the distance between the eNB and UE#2. Hence, the guard period in a subframe transmitted between the eNB and UE#3 is longer than the guard period in a subframe transmitted between the eNB and UE#2. In the example depicted in FIG. 5A, the length of a guard period in a subframe transmitted between the eNB and UE#3 is three symbol periods. The length of a guard period in a subframe transmitted between the eNB and UE#4 is also three symbol periods.

The ratio between the lengths of the downlink and uplink regions (this may be hereinafter referred to as a “DL/UL ratio”) in each subframe depends on downlink traffic and uplink traffic. When data is transmitted from the eNB to a UE, the eNB may determine a DL/UL ratio. When data is transmitted from a UE to the eNB, the UE may determine a DL/UL ratio.

UEs (UE#1-UE#4) are each allocated a subcarrier of a different frequency. In the examples depicted in FIGS. 5A and 5B, frequencies f1-f4 are allocated to UE#1-UE#4, respectively.

As described above, the DL/UL ratio of each subframe is determined for each user equipment. The length of a guard period in each subframe is also determined for each user equipment. Thus, radio resources can be flexibly allocated to the individual user equipments. Accordingly, the wireless communication method in accordance with embodiments increases the efficiency in use of radio resources.

In the meantime, no signals are transmitted during a guard period. Thus, in terms of the efficiency in use of radio resources, radio resources are considered to be wasted during a guard period. Accordingly, the wireless communication method in accordance with embodiments allows radio resources in a guard period for a certain UE to be reused by another UE.

In, for example, a subframe of UE#1, first-fourth symbols are allocated to a downlink region, a fifth symbol is allocated to a guard period, and sixth-sixteenth symbols are allocated to an uplink region. In this case, for the first-fourth symbols, radio resources in a guard period of another UE can be reused for the downlink of UE#1. For the sixth-sixteenth symbols, radio resources in a guard period of another UE can be reused for the uplink of UE#1.

In particular, reusable radio resources are represented as regions marked by oblique lines in FIG. 5B. That is to say, a fourth symbol of the subframe of UE#2, third and fourth symbols of the subframe of UE#3, and a fourth symbol of the subframe of UE#4 can be reused for the downlink of UE#1. A sixth symbol of the subframe of UE#4 can be reused for the uplink of UE#1. The fifth symbol is used as a guard period in the subframe of UE#1. Accordingly, for the fifth symbol, UE#1 does not reuse radio resources that are allocated to a guard period of another UE.

Assume, for example, that the fourth symbol of the subframe of UE#2 is reused for the downlink of UE#1. In this case, eNB1 can transmit downlink data to UE#1 using the first-fourth symbols of subcarrier f1 and the fourth symbol of subcarrier f2. Further assume that the sixth symbol of the subframe of UE#4 is reused for the uplink of UE#1. In this case, UE#1 can transmit uplink data to eNB1 using the sixth-sixteenth symbols of subcarrier f1 and the sixth symbol of subcarrier f4.

However, one resource element maybe refused by another UE. Assume, for example, that the third symbol of the subframe of UE#3 is reused for the downlink of UE#2. In this case, this resource element (i.e., the third symbol of subcarrier f3) cannot be reused for UE#1.

In the wireless communication method in accordance with embodiments, as described above, some of the radio resources in a guard period for a certain UE are reused for another UE. Hence, the efficiency in use of radio resources is increased.

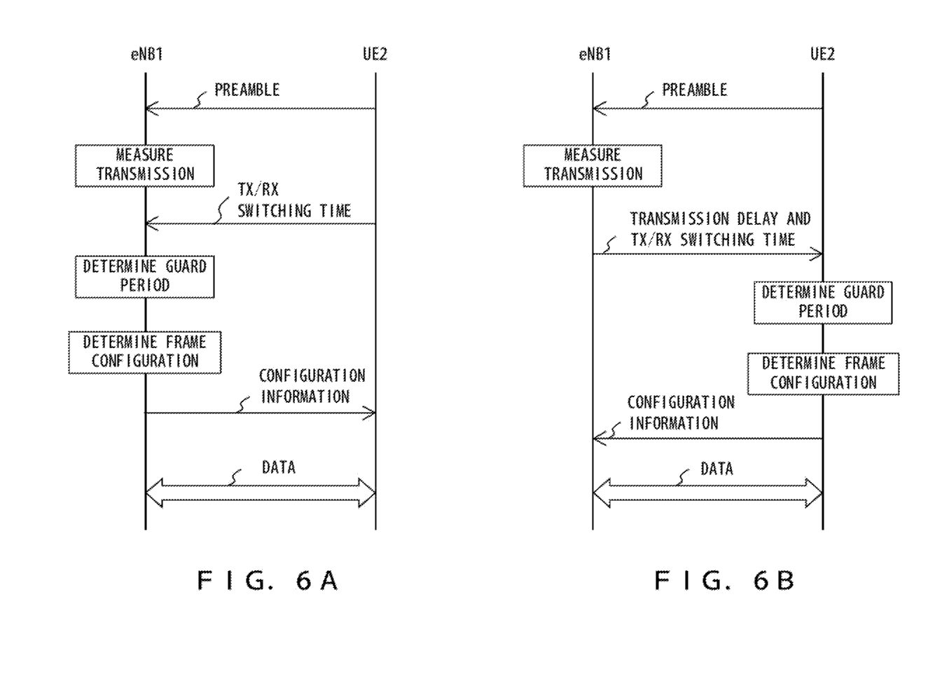

FIGS. 6A and 6B illustrate examples of sequences for establishing a wireless link. In the example depicted in FIG. 6A, eNB1 determines a configuration for a subframe. In the example depicted in FIG. 6B, UE2 determines a configuration for a subframe.

In a case where eNB1 determines a configuration for a subframe, a preamble signal is transmitted from UE2 to eNB1. The preamble signal is transmitted via a PRACH. eNB1 measures a transmission delay between UE2 and eNB1 using the preamble signal.

UE2 notifies eNB1 of a TX/RX switching time of UE2. The TX/RX switching time of UE2 indicates a time needed to switch between a transmission process and a reception process within UE2. In this example, the TX/RX switching time of UE2 depends on the configuration of the hardware of UE2 (transmission circuit 13, multiplexer 14, radio transmitter 15, switch 16, radio receiver 18, and the reception circuit 19, among other things), and the TX/RX switching time of UE 2 is a known time.

eNB1 determines a length for the guard period according to the transmission delay between UE2 and eNB1, the TX/RX switching time of UE2, and the TX/RX switching time of eNB1. The TX/RX switching time of eNB1 indicates a time needed to switch between a transmission process and a reception process within eNB1. In this example, the TX/RX switching time of eNB1 depends on the configuration of the hardware of eNB1 (transmission circuit 43, multiplexer 44, radio transmitter 45, switch 46, radio receiver 48, and the reception circuit 49, among other things), and the TX/RX switching time of eNB1 is a known time.

A length is determined for the guard period according to, for example, the sum of the transmission delay between UE2 and eNB1, the TX/RX switching time of UE2, and the TX/RX switching time of eNB1. However, the TX/RX switching time of eNB1 is common to all UEs. Accordingly, a length may be determined for the guard period according to the sum of the transmission delay between UE2 and eNB1 and the TX/RX switching time of UE2. In addition, when the UEs have an identical TX/RX switching time or TX/RX switching periods almost identical with each other, a length may be determined for the guard period according to the transmission delay between UE2 and eNB1. In this example, in any case, a length is determined for the guard period according to at least the transmission delay between UE2 and eNB1. Note that the transmission delay between UE2 and eNB1 substantially corresponds to the distance between UE2 and eNB1.

Subsequently, eNB1 determines a configuration for the subframe. The configuration of the subframe is defined by the DL/UL ratio, the length of the guard period, and the position of the guard period. However, the position of the guard period may be calculated from the DL/UL ratio. Thus, the configuration of the subframe may be defined by the DL/UL ratio and the length of the guard period. eNB1 notifies UE2 of configuration information indicating the configuration of the subframe. UE2 may be notified of the configuration information by eNB1 through semi-static signaling (e.g., RRC signaling or MAC signaling). Alternatively, UE2 may be notified of the configuration information by eNB1 through dynamic signaling (e.g., PDCCH). Then, a data communication is performed between eNB1 and UE2 using the subframe described above.

Also in a case where UE2 determines a configuration for the subframe, eNB1 measures the transmission delay between UE2 and eNB1. However, eNB1 notifies UE2 of a measured value of the transmission delay. eNB1 also notifies UE2 of the TX/RX switching time of eNB1. UE2 is notified of the measured value of the transmission delay and the TX/RX switching time of eNB1 by eNB1 through, for example, RRC signaling or MAC signaling.

UE2 determines a length for the guard period and also determines a configuration for the subframe. The method used by UE2 for determining a length for the guard period and a configuration for the subframe is substantially the same as the method used by eNB1. UE2 notifies eNB1 of configuration information indicating the configuration of the subframe. eNB1 is notified of the configuration information by UE2 through MAC signaling or dynamic signaling. Then, a data communication is performed between eNB1 and UE2 using the subframe described above.

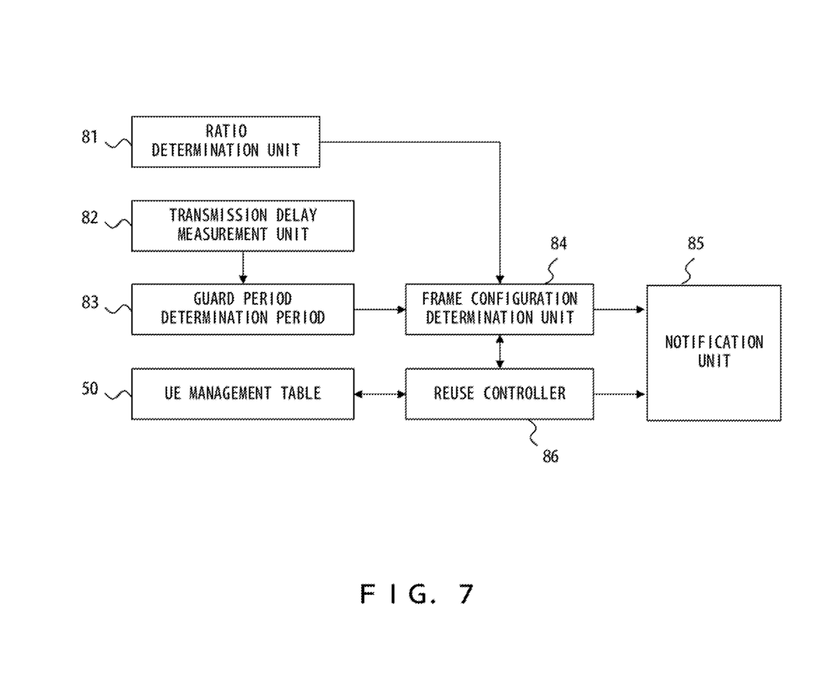

FIG. 7 illustrates an example of functions of eNB1 that are related to resource allocation. To allocate radio resources, eNB1 includes a ratio determination unit 81, a transmission delay measurement unit 82, a guard period determination unit 83, a frame configuration determination unit 84, a notification unit 85, and a reuse controller 86. According to the configuration depicted in FIG. 4, the ratio determination unit 81, the transmission delay measurement unit 82, the guard period determination unit 83, the frame configuration determination unit 84, the notification unit 85, and the reuse controller 86 may be implemented mainly by the frame generator 41 and the MAC/RRC controller 42. Accordingly, a processor system that includes a processor element and a memory may implement the ratio determination unit 81, the transmission delay measurement unit 82, the guard period determination unit 83, the frame configuration determination unit 84, the notification unit 85, and the reuse controller 86.

The ratio determination unit 81 determines a ratio to be achieved between a downlink region and an uplink region (i.e., DL/UL ratio) fora subframe according to downlink traffic and uplink traffic. Downlink and/or uplink traffic is requested by, for example, a user. The transmission delay measurement unit 82 measures a transmission delay between UE2 and eNB1 using a preamble signal transmitted from UE2. The guard period determination unit 83 determines a length for a guard period according to the transmission delay between UE2 and eNB1. Meanwhile, the guard period determination unit 83 may determine a length for the guard period in consideration of the TX/RX switching time of UE2 and/or the TX/RX switching time of eNB1.

The frame configuration determination unit 84 determines a configuration for a subframe according to a DL/UL ratio and the length of the guard period. Configuration information indicating configurations of subframes is stored in the UE management table 50. The notification unit 85 notifies UE2 of configuration information indicating the configuration of the subframe. Descriptions will be given of the reuse controller 86 hereinafter.

In FIG. 4, control information supplied to the frame generator 41 includes a request for downlink and/or uplink traffic.

The control information also includes information indicating the length of a guard period, the TX/RX switching time of UE2, and the TX/RX switching time of eNB1.

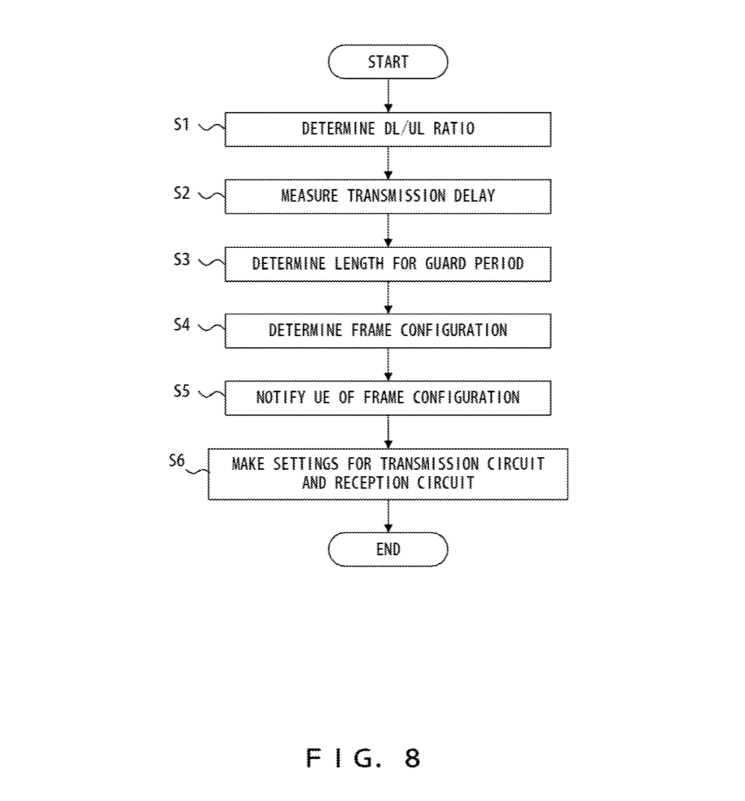

FIG. 8 is a flowchart indicating an example of a process performed by an eNB in a sequence for establishing a wireless link. The flowchart depicted in FIG. 8 indicates an example of a process performed by eNB1 in the sequence depicted in FIG. 6A.

In S1, the ratio determination unit 81 determines a DL/UL ratio according to downlink traffic and uplink traffic. In S2, the transmission delay measurement unit 82 measures a transmission delay between UE2 and eNB1 using a preamble signal transmitted from UE2. In S3, the guard period determination unit 83 determines a length for a guard period according to at least the transmission delay between UE2 and eNB1. In S4, the frame configuration determination unit 84 determines a configuration fora subframe according to the DL/UL ratio and the length of the guard period. In S5, the notification unit 85 notifies UE2 of configuration information indicating the configuration of the subframe. In S6, settings are made for the transmission circuit 43 and the reception circuit 49 according to the configuration of the subframe determined in S5.

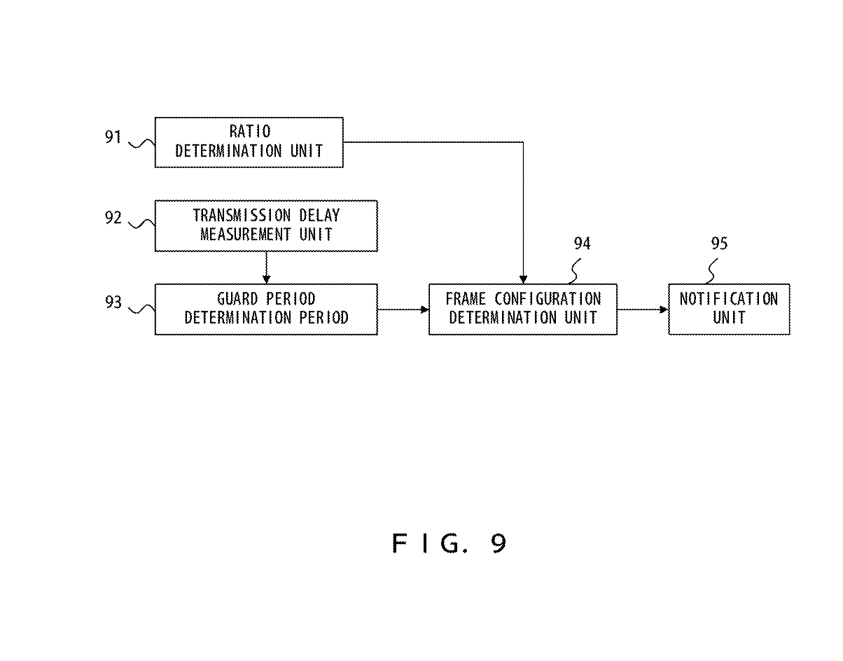

FIG. 9 illustrates an example of functions of UE2 that are related to resource allocation. To allocate radio resources, UE2 includes a ratio determination unit 91, a transmission delay measurement unit 92, a guard period determination unit 93, a frame configuration determination unit 94, and a notification unit 95. According to the configuration depicted in FIG. 3, the ratio determination unit 91, the transmission delay measurement unit 92, the guard period determination unit 93, the frame configuration determination unit 94, and the notification unit 95 may be implemented mainly by the frame generator 11 and the MAC/RRC controller 12. Accordingly, a processor system that includes a processor element and a memory may implement the ratio determination unit 91, the transmission delay measurement unit 92, the guard period determination unit 93, the frame configuration determination unit 94, and the notification unit 95.

The ratio determination unit 91 determines a DL/UL ratio according to downlink traffic and uplink traffic. The transmission delay measurement unit 92 measures a transmission delay between UE2 and eNB1 by transmitting a preamble signal to eNB1 using the preamble processor 24 depicted in FIG. 3. In practice, eNB1 notifies UE2 of a measured value of the transmission delay obtained by eNB1. The guard period determination unit 93 determines a length for a guard period according to the transmission delay between UE2 and eNB1. Meanwhile, the guard period determination unit 93 may determine a length for the guard period in consideration of the TX/RX switching time of UE2 and/or the TX/RX switching time of eNB1.

The frame configuration determination unit 94 determines a configuration for a subframe according to a DL/UL ratio and the length of the guard period. The notification unit 95 notifies eNB1 of configuration information indicating the configuration of the subframe.

In FIG. 3, control information supplied to the frame generator 11 includes a request for downlink and/or uplink traffic. The control information also includes information indicating the length of a guard period, the TX/RX switching time of UE2, and the TX/RX switching time of eNB1.

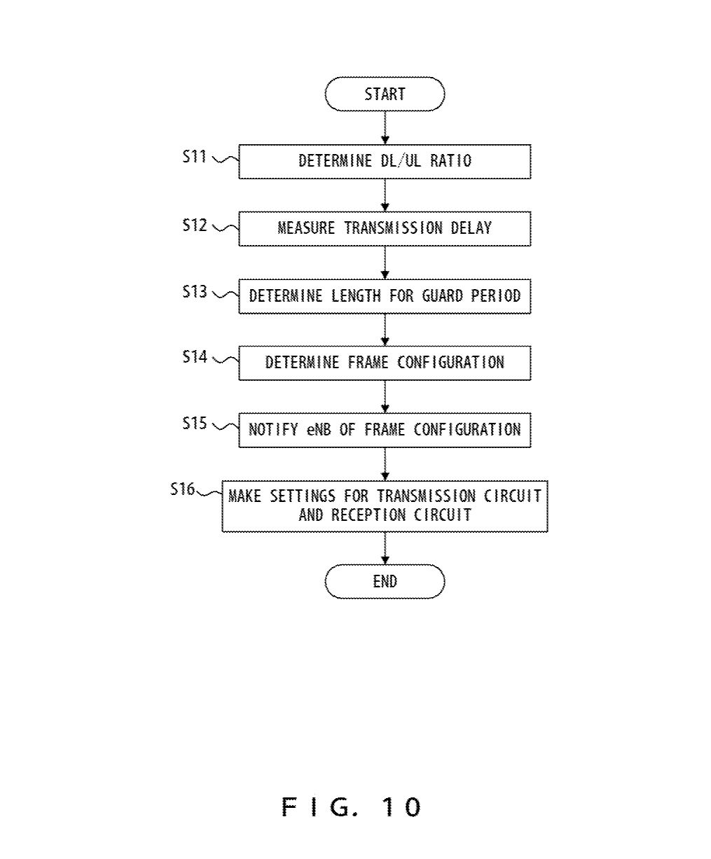

FIG. 10 is a flowchart indicating an example of a process performed by a UE in a sequence for establishing a wireless link. The flowchart depicted in FIG. 10 indicates an example of a process performed by UE2 in the sequence depicted in FIG. 6B.

In S11, the ratio determination unit 91 determines a DL/UL ratio according to downlink traffic and uplink traffic. In S12, the transmission delay measurement unit 92 obtains a measured value of a transmission delay between UE2 and eNB1 from eNB1 by transmitting a preamble signal to eNB1. In S13, the guard period determination unit 93 determines a length for a guard period according to at least the transmission delay between UE2 and eNB1. In S14, the frame configuration determination unit 94 determines a configuration for a subframe according to the DL/UL ratio and the length of the guard period. In S15, the notification unit 95 notifies eNB1 of configuration information indicating the configuration of the subframe. In S16, settings are made for the transmission circuit 13 and the reception circuit 19 according to the configuration of the subframe determined in S15.

In the sequences depicted in FIGS. 6A and 6B, configuration information may be transmitted between eNB1 and UE through dynamic signaling. For example, dynamic signaling may be reported through a NR control channel. In this case, downlink control information (DCI) indicating the configuration of a subframe and the position and length of a guard period may be transmitted as configuration information between eNB1 and UE2 through the NR control channel.

Reuse of Radio Resources

In the wireless communication method in accordance with embodiments of the invention, as described above, some of the radio resources to which a guard period for a certain UE has been allocated are reused by another UE. For example, a long guard period is used for a subframe of a UE that is located far from eNB1 (hereinafter referred to as a distant UE). Meanwhile, a short guard period is used for a subframe of a UE that is located near eNB1 (hereinafter referred to as a nearby UE). Accordingly, some of the radio resources to which the guard period for the distant UE is allocated may be reused for a downlink transmission and/or an uplink transmission of the nearby UE.

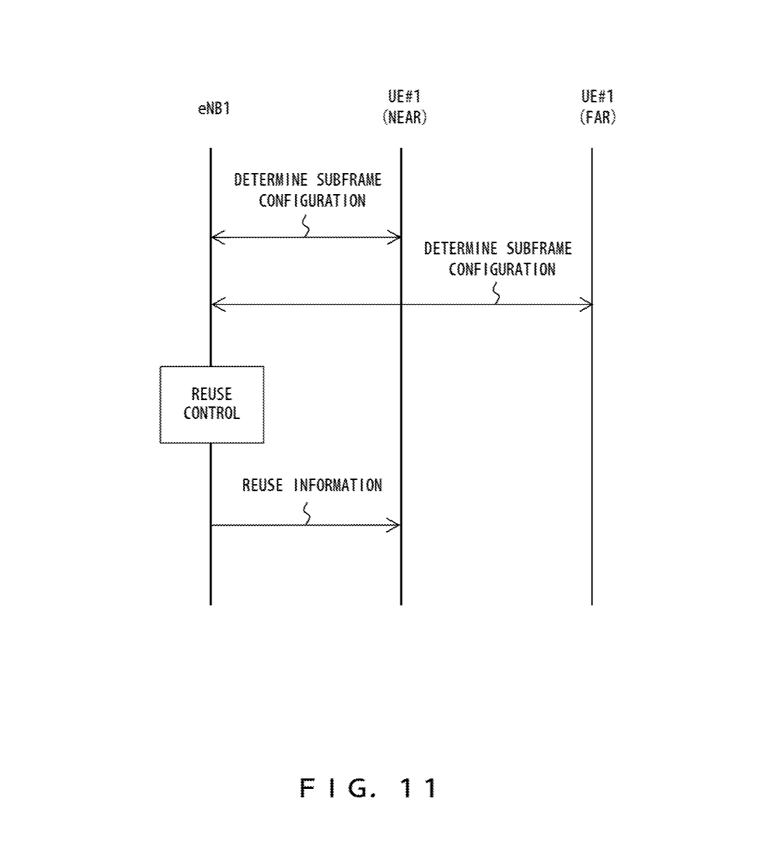

FIG. 11 illustrates an example of a sequence for reusing radio resources. In the example depicted in FIG. 11, eNB1 accommodates UE#1 and UE#3 UE#1 (nearby UE) is located close to eNB1 UE#3 (distant UE) is located far from eNB1 (i.e., close to a cell edge).

A configuration is determined for a subframe to be used for a communication between eNB1 and UE#1 through the sequence depicted in FIG. 6A or 6B. The length of the guard period of this subframe is one symbol period, as depicted in FIG. 5A. Similarly, a configuration is determined for a subframe to be used for a communication between eNB1 and UE#3 through the sequence depicted in FIG. 6A or 6B. However, the length of the guard period of this subframe is three symbol periods, as depicted in FIG. 5A.

In this case, eNB1 performs radio-resource reuse control such that some of the radio resources allocated to the guard period of the distant UE are reused for a downlink transmission and/or an uplink transmission of the nearby UE. In particular, eNB1 performs radio-resource reuse control such that some of the radio resources allocated to the guard period of UE#3 are reused by UE#1. Note that the reuse control is performed by the reuse controller 86 depicted in FIG. 7.

When eNB1 determines radio resources to be reused, eNB1 notifies the corresponding UE2 of reuse information indicating the radio resources to be reused. For example, eNB1 may notify the corresponding UE2 of the reuse information through control signaling.

As indicated in FIG. 5B, the reuse controller 86 may allocate third and fourth symbols of subcarrier f3 to UE#1. In this case, the reuse controller 86 may allocate only one of the symbols to UE#1 or may allocate both of the symbols to UE#1. In this example, the fourth symbol of subcarrier f3 is allocated to UE#1.

In this situation, eNB1 notifies UE#1 of reuse information indicating that the fourth symbol of subcarrier f3 can be used. For example, eNB1 may notify UE#1 of the reuse information through MAC signaling, RRC signaling, or PDCCH. Upon receipt of the reuse information, UE#1 reconfigures a subframe to be used for a communication between eNB1 and UE#1. In this example, a subframe is configured for transmitting a downlink signal using first-four symbols of subcarrier f1 and a fourth symbol of subcarrier f3 and transmitting an uplink signal using sixth-sixteenth symbols of subcarrier f1.

As result, the capacity of the downlink between eNB1 and UE#1 is increased. In particular, the efficiency in use of radio resources is increased.

For downlink, radio resources allocated for reuse may be used to transmit PDCCH/PDSCH. In this case, for example, a downlink allocation signal or an uplink grant signal may be transmitted. Alternatively, the radio resources allocated for reuse may be used to transmit a Channel State Information Reference Signal (CSI-RS). For uplink, radio resources allocated for reuse may be used to transmit PUCCH/PUSCH. Alternatively, the radio resources allocated for reuse may be used to transmit a sounding reference signal.

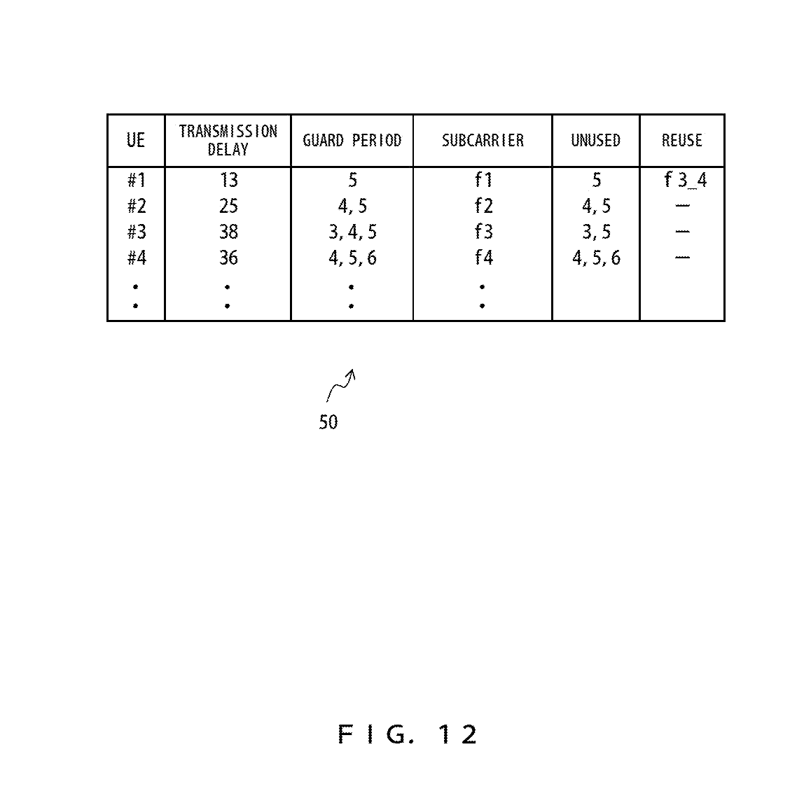

FIG. 12 illustrates an example of the UE management table 50. The UE management table 50 stores information related to allocation of radio resources for each UE accommodated by eNB1. Note that the UE management table 50 is created within a storage device of eNB1.

“TRANSMISSION DELAY” indicates a measured value of a transmission delay between eNB1 and UE2. “GUARD PERIOD” indicates the position and length of a guard period determined according to a transmission delay and the like. For example, for the subframe of UE#1, a fifth symbol is used as a guard period. For the subframe of UE#3, third-fifth symbols are used as a guard period. “SUBCARRIER” indicates a frequency for transmitting a data signal and a control signal between eNB1 and UE2. “UNUSED” indicates a symbol that has not been reused by another UE from among symbols to which a guard period has been allocated. “REUSE” indicates radio resources that are reused by another UE.

The UE management table 50 depicted in FIG. 12 indicates the state depicted in FIG. 5A. In the example depicted in FIG. 12, the fourth symbol of UE#3 is reused by UE#1. Note that a “REUSE: f3_4” indicates a state in which the fourth symbol of subcarrier f3 is reused.

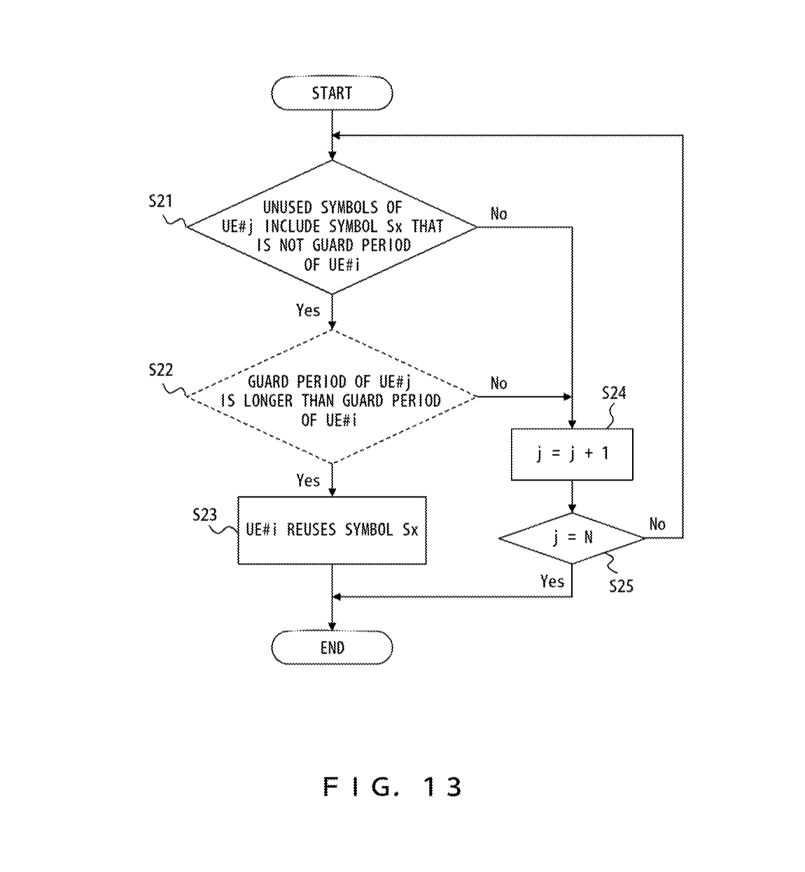

FIG. 13 is a flowchart indicating an example of a process of reusing radio resources. The following descriptions are based on the assumption that eNB1 accommodates UE#1 through UE#N. The process of this flowchart is performed for each UE accommodated by eNB1 (hereinafter referred to as UE#i (i=1 to N)).

In S21, the reuse controller 86 refers to the UE management table 50 so as to decide whether unused symbols in a subframe of UE#j (i.e., symbols that have been designated as a guard period and that have not been reused by another UE) include a symbol Sx that is not a guard period in the subframe of UE#i. Note that UE#j indicates a UE that is not UE#i. When symbol Sx is included, the reuse controller 86 compares, in S22, the length of the guard period in the subframe of UE#i with the length of the guard period in the subframe of UE#j. When the guard period of UE#j is longer than the guard period of UE#i, the reuse controller 86 allocates, in S23, radio resources such that the symbol Sx of UE#j is reused by UE#i.

When UE#j does not have a symbol Sx (S21: No), or when the guard period of UE#j is not longer than the guard period of UE#i (S22: No), a next UE is selected (S24-S25).

Descriptions will be given of the process of the flowchart of FIG. 13 by referring to the example indicated in FIG. 12. Assume that UE#i=UE#1. In this case, unused symbols of UE#3 are “3”, “4”, and “5” in S21. Meanwhile, the guard period of UE#1 is “5”. Thus, third and fourth symbols of UE#3 are extracted as symbols Sx. In S22, the length of the guard period of UE#1 is “1”, and the guard period of UE#3 is “3”. Hence, the guard period of UE#3 is longer than the guard period of UE#1.

Accordingly, the third and fourth symbols of UE#3 may be reused by UE#1. In the example indicated in FIG. 12, however, the fourth symbol of UE#3 is reused by UE#1. For example, the amount of radio resources to be reused may be determined in advance or may be determined according to a request of each UE.

Performing S22 in the flowchart depicted in FIG. 13 allows radio resources allocated to the guard period of a distant UE to be reused by a nearby UE. However, the embodiments of the present invention are not limited to this method. In particular, the reuse controller 86 may skip the process of S22. In this case, radio resources allocated to the guard period of a certain UE may be reused by another UE.

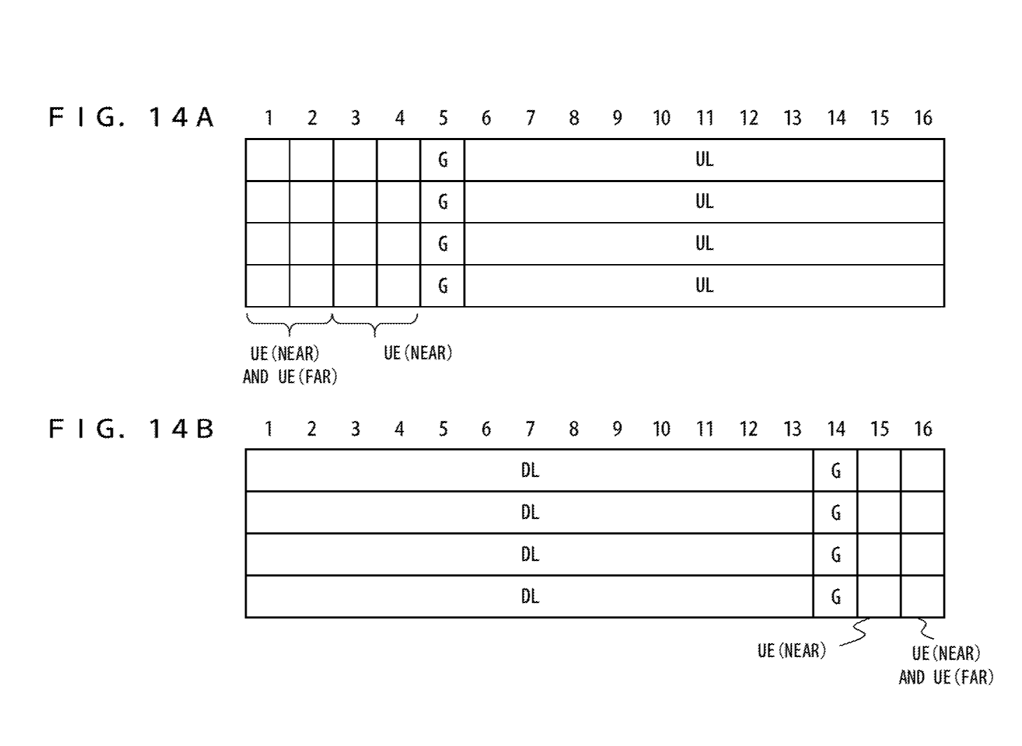

FIGS. 14A and 14B illustrate examples of allocation and reuse of radio resources. FIG. 14A depicts an example of the configuration of a subframe in which an uplink is dominant. In this example, the sixth-sixteenth symbols are allocated to the uplink. For a UE that is located close to eNB1, i.e., UE (NEAR), the first-fourth symbols are allocated to a downlink, and the fifth symbol is used as a guard period. For a UE that is located far from eNB1, i.e., UE (FAR), the first and second symbols are allocated to the downlink, and the third-fifth symbols are used as a guard period. The symbols allocated to the guard period for UE (FAR) may be reused by UE (NEAR). eNB1 notifies the corresponding UE (NEAR) of the reuse of radio resources through control signalling.

FIG. 14B depicts an example of the configuration of a subframe in which a downlink is dominant. In this example, the first-thirteenth symbols are allocated to the downlink. For a UE located that is located close to eNB1, i.e., UE (NEAR), the fifteenth and sixteenth symbols are allocated to the uplink, and the fourteenth symbol is used as a guard period. For a UE that is located far from eNB1, i.e., UE (FAR), the sixteenth symbol is allocated to the uplink, and the fourteenth and fifteenth symbols are used as a guard period.

The symbols allocated to the guard period for UE (FAR) may be reused by UE (NEAR). eNB1 notifies the corresponding UE (NEAR) of the reuse of radio resources through control signalling.

In the examples depicted in FIGS. 11-13, eNB1 determines radio resources to be reused according to the guard period of each UE and notifies a corresponding UE2 of reuse information indicating the radio resources to be reused. In the example described below, by contrast, radio resources to be reused are designated in accordance with rules determined in advance.

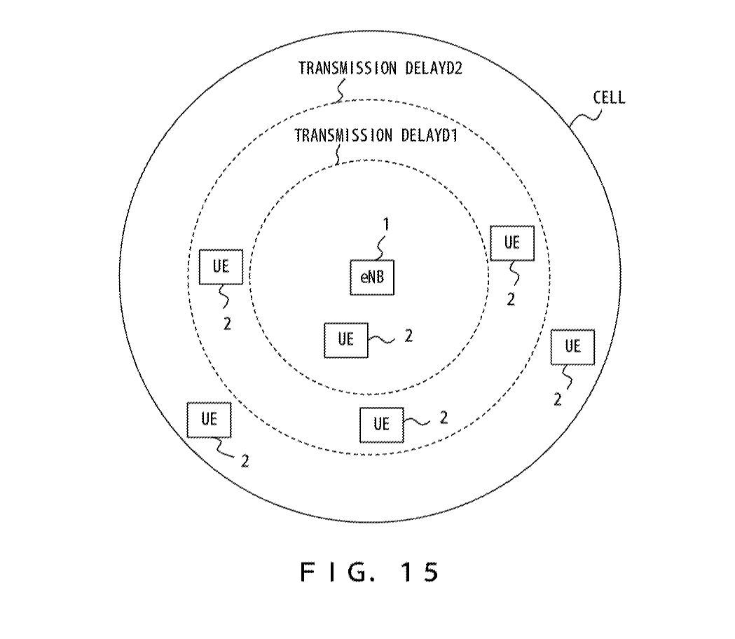

UE2s accommodated by eNB1 are grouped in accordance with a transmission delay time. In the example depicted in FIG. 15, three groups are defined. UE2s having a transmission delay that is less than D1 for a communication with eNB1 belong to a nearby group. UE2s having a transmission delay that is greater than D1 and less than D2 for a communication with eNB1 belong to a middle group. UE2s having a transmission delay that is greater than D2 for a communication with eNB1 belong to a distant group.

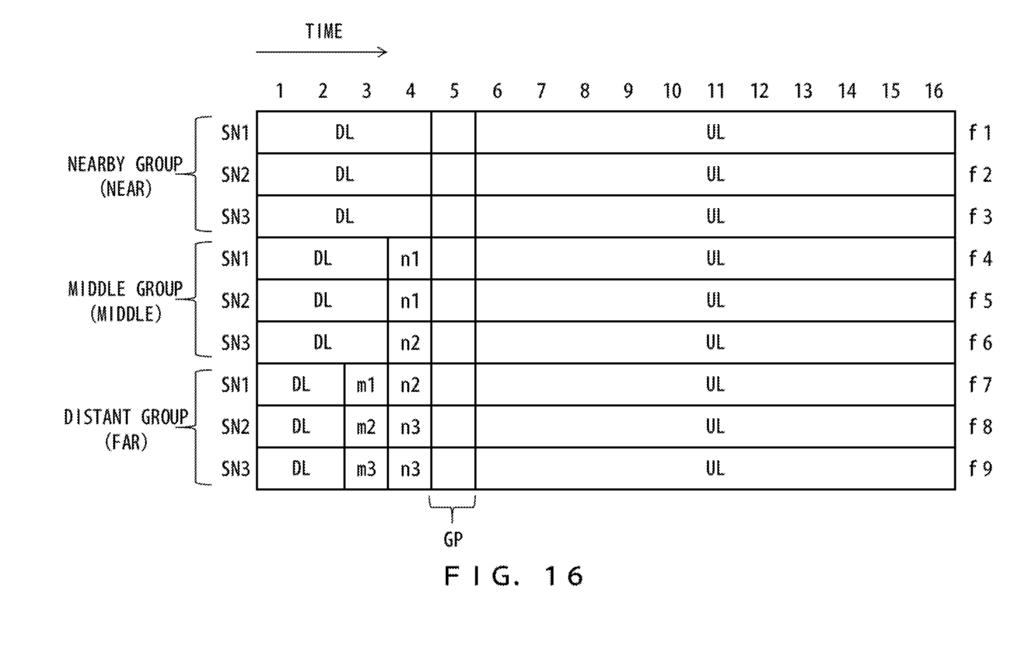

eNB1 may accommodate a specified number of UE2s for each group. In the example depicted in FIG. 16, eNB1 may accommodate three UE2s for each group. The fifth symbol is used as a guard period for the UE2s belonging to the nearby group. The fourth and fifth symbols are used as a guard period for the UE2s belonging to the middle group.

The third through fifth symbols are used as a guard period for the UE2s belonging to the distant group.

The following are rules for reusing radio resources.
(1) The fourth symbols of subcarriers f4 and f5 are reused by a UE_SN1 belonging to the nearby group.
(2) The fourth symbols of subcarriers f6 and f7 are reused by a UE SN2 belonging to the nearby group.
(3) The fourth symbols of subcarriers f8 and f9 are reused by a UE SN3 within the nearby group.
(4) The third symbol of subcarrier f7 is reused by a UE SN1 belonging to the middle group.
(5) The third symbol of subcarrier f8 is reused by a UE SN2 belonging to the middle group.
(6) The third symbol of subcarrier f9 is reused by a UE SN3 belonging to the middle group.

In FIG. 16, SN1-SN3 indicate serial numbers for identifying UEs within each group. The serial number is generated by eNB1 when, for example, a UE issues a communication start request. “ni” indicates a UE to which a serial number i within the nearby group is assigned. Similarly, “mi” indicates a UE to which a serial number i within the middle group is assigned.

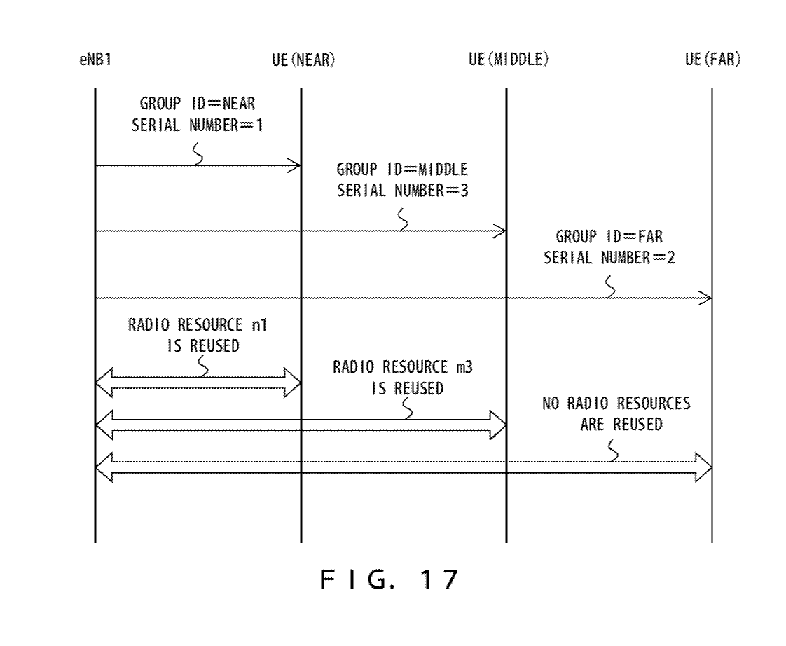

FIG. 17 illustrates another example of a sequence for reusing radio resources. In FIG. 17, eNB1 accommodates UE (NEAR), UE (MIDDLE), and UE (FAR). UE (NEAR), UE (MIDDLE), and UE (FAR) belong to a nearby group, a middle group, and a distant group, respectively.

In a sequence for determining a subframe configuration for a communication between eNB1 and UE (NEAR), eNB1 notifies UE (NEAR) of a group ID and a serial number. Group IDs identify the nearby group, the middle group, and the distant group. Accordingly, UE (NEAR) is notified of “GROUP ID: NEAR”. In this example, serial number 1 is assigned to UE (NEAR). In this case, UE (NEAR) may reuse radio resources represented as “n1” in FIG. 16. Hence, UE (NEAR) may reuse the fourth symbols of subcarriers f4 and f5.

Similarly, in a sequence for determining a subframe configuration for a communication between eNB1 and UE (MIDDLE), eNB1 notifies UE (MIDDLE) of a group ID and a serial number. UE (MIDDLE) is notified of “GROUP ID: MIDDLE”. In this example, serial number 3 is assigned to UE (MIDDLE). In this case, UE (MIDDLE) may reuse radio resources represented as “m3” in FIG. 16. Hence, UE (MIDDLE) may reuse the third symbol of subcarrier f9.

In the sequence indicated in FIGS. 15-17, as described above, radio resources to be reused are designated in accordance with the rules determined in advance. Hence, neither the process of the flowchart depicted in FIG. 13 nor signaling for reporting a result of the process needs to be performed.

Subframe and Radio Frame

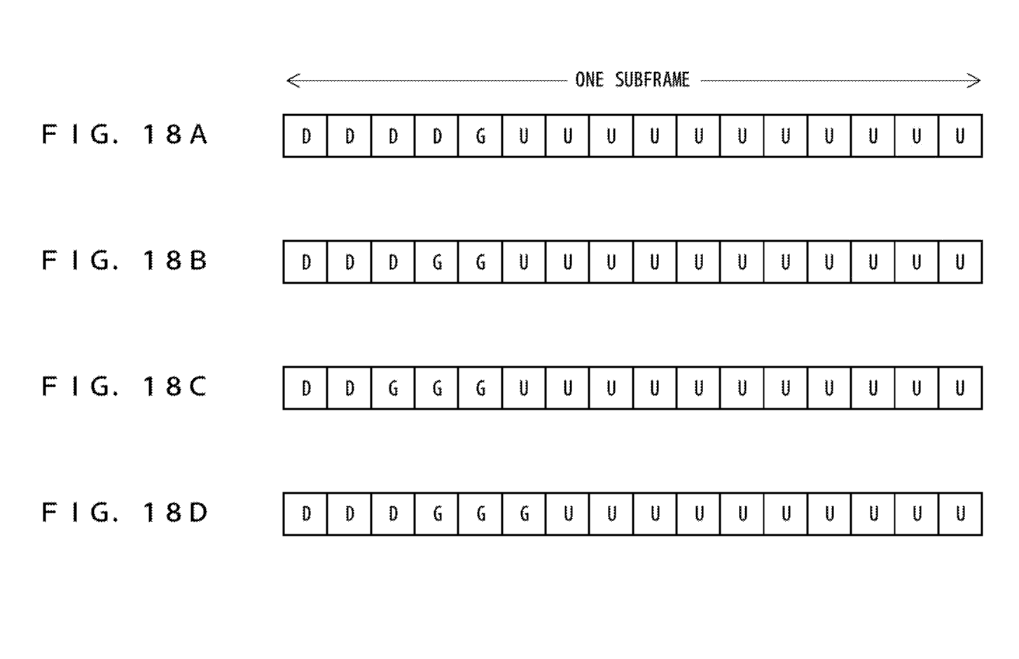

In the examples described above, a desired DL/UL ratio is achieved by adjusting the lengths of a downlink region an uplink region in a subframe. In the example depicted in FIG. 18A, “DL/UL ratio=4:11” is achieved in a subframe having a guard period of one frame. In the example depicted in FIG. 18B, “DL/UL ratio=3:11” is achieved in a subframe having a guard period of two frames. In the example depicted in FIG. 18C, “DL/UL ratio=2:11” is achieved in a subframe having a guard period of three frames. In the example depicted in FIG. 18D, “DL/UL ratio=3:10” is achieved in a subframe having a guard period of three frames.

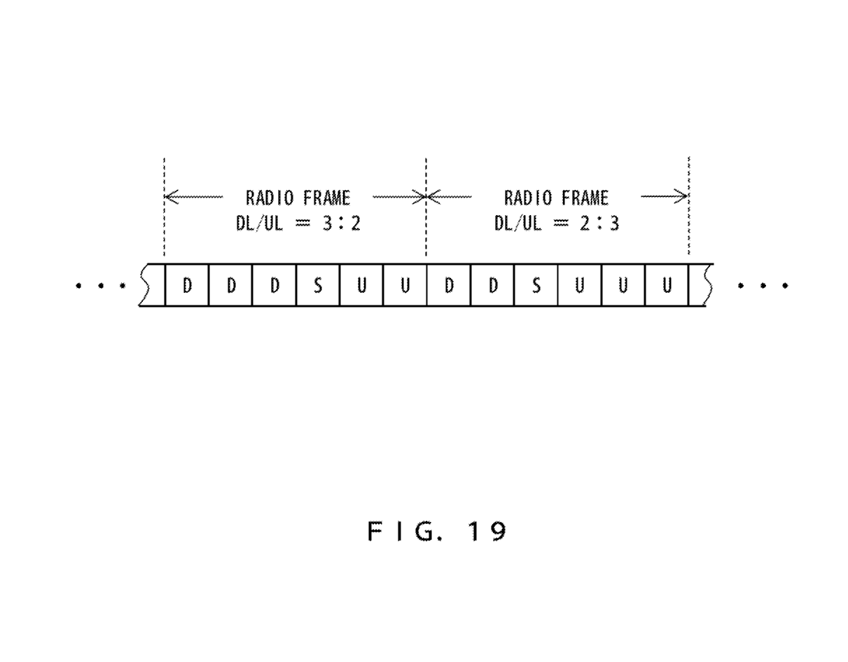

In the example depicted in FIG. 19, a desired DL/UL ratio is achieved for each radio frame. In this example, each radio frame includes six subframes. D, S, and U in FIG. 19 indicate a downlink subframe, a special subframe, and an uplink subframe, respectively. A special subframe is provided between a downlink subframe and an uplink subframe in the radio frame so as to mitigate interference between a downlink and an uplink. Accordingly, a special subframe corresponds to a guard period. A needed DL/UL ratio is adjusted in accordance with the numbers of downlink subframes and uplink subframes in the radio frame. The configuration of the radio frame is communicated between eNB1 and UE2 through semi-static signaling or dynamic signaling.

The number of subframes in a radio frame may be dynamically changed. For example, a radio frame may include two subframes or may include twelve subframes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A base station device that communicates with a user equipment by using a frame including a downlink region in which a signal for a downlink is allocated and an uplink region in which a signal for an uplink is allocated, the base station device comprising:
a guard period determination unit configured to determine a length of a guard period provided between the downlink region and the uplink region based on a transmission delay between the base station device and the user equipment;
a frame configuration determination unit configured to determine a configuration of the frame based on the length of the guard period;
a notification unit configured to notify the user equipment of configuration information that indicates the configuration of the frame determined by the frame configuration determination unit; and
a communication circuit configured to communicate with the user equipment based on the configuration of the frame determined by the frame configuration determination unit.

2. The base station device according to claim 1, wherein the notification unit notifies the user equipment of the configuration information by using dynamic signaling.

3. The base station device according to claim 1, wherein the notification unit notifies the user equipment of the configuration information by using MAC signaling or RRC signaling.

4. The base station device according to claim 1, further comprising:
a ratio determination unit configured to determine a ratio between a length of the downlink region and a length of the uplink region in the frame according to downlink traffic and uplink traffic, wherein
the frame configuration determination unit determines a configuration of the frame according to the ratio and the length of the guard period.

5. The base station device according to claim 1, wherein
information indicating a ratio between a length of the downlink region and a length of the uplink region in the frame is notified from the user equipment to the base station device by using semi-static signaling or dynamic signaling, and
the frame configuration determination unit determines a configuration of the frame according to the ratio and the length of the guard period.

6. The base station device according to claim 1, further comprising:
a reuse controller configured to allocate, when a link for transmitting a frame that includes a first guard period is established in a communication with a first user equipment using a first frequency and a link for transmitting a frame that includes a second guard period is established in a communication with a second user equipment using a second frequency, radio resources of at least a portion of the second guard period of the second frequency to the communication with the first user equipment.

7. The base station device according to claim 6, wherein
the reuse controller allocates the radio resources of at least a portion of the second guard period of the second frequency to the communication with the first user equipment when the second guard period is longer than the first guard period.

8. The base station device according to claim 6, wherein
the notification unit notifies the first user equipment of reuse information indicating that radio resources of at least a portion of the second guard period of the second frequency have been allocated to the first user equipment.

9. A user equipment that communicates with a base station by using a frame including a downlink region in which a signal for a downlink is allocated and an uplink region in which a signal for an uplink is allocated, the user equipment comprising:
a guard period determination unit configured to determine a length of a guard period provided between the downlink region and the uplink region based on a transmission delay between the user equipment and the base station;
a frame configuration determination unit configured to determine a configuration of the frame based on the length of the guard period;
a notification unit configured to notify the base station of configuration information that indicates the configuration of the frame determined by the frame configuration determination unit; and
a transceiver circuit configured to communicate with the base station based on the configuration of the frame determined by the frame configuration determination unit.

10. The user equipment according to claim 9, further comprising:
a ratio determination unit configured to determine a ratio between a length of the downlink region and a length of the uplink region in the frame according to downlink traffic and uplink traffic, wherein
the frame configuration determination unit determines a configuration of the frame according to the ratio and the length of the guard period.

11. A wireless communication method for performing a communication between a base station and a user equipment by using a frame including a downlink region in which a signal for a downlink is allocated and an uplink region in which a signal for an uplink is allocated, the wireless communication method comprising:
determining a length of a guard period provided between the downlink region and the uplink region based on a transmission delay between the base station and the user equipment; and
performing a communication between the base station and the user equipment using a frame in which the guard period is provided between the downlink region and the uplink region.

12. The wireless communication method according to claim 11, further comprising:
allocating, when a link for transmitting a frame that includes a first guard period is established in a communication between the base station and a first user equipment using a first frequency and a link for transmitting a frame that includes a second guard period is established in a communication between the base station and a second user equipment using a second frequency, radio resources of at least a portion of the second guard period of the second frequency to the communication between the base station and the first user equipment.

13. The wireless communication method according to claim 12, wherein
the base station notifies the first user equipment of reuse information indicating that the radio resources of at least a portion of the second guard period of the second frequency have been allocated to the first user equipment, and
the first user equipment reuses, according to the reuse information, the radio resources of at least a portion of the second guard period of the second frequency for the communication with the base station.

14. The wireless communication method according to claim 12, wherein
a guard period position is designated in advance for each of a plurality of subcarriers available for a communication between the base station and a user equipment accommodated by the base station,
a rule is established in advance such that radio resources of a portion of a guard period of a first subcarrier of the plurality of subcarriers are reused for a communication performed using a second subcarrier, and
a user equipment to which the second subcarrier has been allocated by the base station reuses the radio resources of a portion of the guard period of the first subcarrier.
